(19) United States
(12) Patent Application Publication
(10) Pub. No.: US 2009/0313645 A1
(43) Pub. Date: Dec. 17, 2009

(54) DYNAMIC DEVICE PROFILE INTERFACES

(75) Inventors: Sailesh Sathish, Tampere (FI); Olli Pettay, Helsinki (FI)

Correspondence Address: FOLEY & LARDNER LLP, P.O. BOX 80278, SAN DIEGO, CA, 92138-0278, US

(73) Assignee: NOKIA Corporation

(21) Appl. No.: 12/545,009

(22) Filed: Aug. 20, 2009

Related U.S. Application Data
(62) Division of application No. 11/484,401, filed on Jul. 11, 2006.

(51) Int. Cl. G06F 9/46

(52) U.S. Cl. 719/328

(57) ABSTRACT

An architecture for context provisioning that is specifically suited for web applications utilizing the delivery context interface (DCI) specification promulgated by the W3C. A client side application programming interface (API) uses a DCI tree to generate a dynamic device profile that provides snapshots of delivery context information (DCI) dynamically during a browser application session. The client side API provides support for the application author to subscribe to various device properties represented in the DCI tree, and generate the dynamic device profile based on property changes.

### CROSS-REFERENCE TO RELATED PATENT APPLICATIONS

This application is a Divisional of U.S. application Ser. No. 11/484,401, filed Jul. 11, 2006, incorporated herein by reference in its entirety.

### FIELD OF THE INVENTION

The present invention generally relates to the use of delivery context interfaces. In particular, the present invention relates to an application programming interface (API) that allows access to dynamic device information from the delivery context interface by creating a dynamic device profile that can be sent to a server at any point during a session.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Mobile information access is gaining widespread prominence with improving connection speeds and access technologies, leading to an explosion of content-rich applications and enhanced user experience. The mobility aspect has also opened up new prospects for application development, as mobile devices are expected to be with users at all times, providing reliable cues as to users' intentions and users' environments. In order to be found useful, the next generation of mobile applications must leverage this mobile aspect of devices and combine that with context awareness to provide customized services and user interfaces. Therefore, the inclusion of context in application development must become the norm. Furthermore, this leveraging of context must be accompanied with a uniform mode of delivery context access.

The majority of existing web pages and web-based applications have been developed for the standard desktop browser. As such, they require very little, if any, adaptation when providing and presenting content to a desktop personal computer (PC) or machine. However, when the same content and applications are accessed through a limited resource device such as a mobile phone, problems arise as to the presentation of, and interaction with that content. Moreover, characteristics of these devices can vary widely between device manufacturers and even between different device models made by the same manufacturer, e.g., screen size, keypad type, screen orientation, and processing speed and capability. As a result, creating web pages optimized for each device configuration is impractical and nearly impossible with present technology.

Apart from device-specific content adaptation, applications during run time should be able to access system and environmental data as well. Such data includes location information, battery life, network signal strength, sensor data, etc. This applies to both mobile and non-mobile applications, because even non-mobile applications are expected to function in heterogeneous environments. For example, a device's configuration, user preferences, and environmental conditions can change, and an application should be able to adapt to such changes.

Adaptive multimodal interfaces constitutes yet another area where utilizing device context information would be advantageous. Multimodal browsing enables a user to browse a multimodal web page using different modalities such as a graphical user interface (GUI), speech, touch, vision, or other mode of interaction. Processors for each modality can either reside on a client terminal, i.e., the device, or on a network. For example, a device can establish web sessions with a remote service such as a network-based, automatic speech recognizer (ASR) that has better capabilities than a device-resident ASR, and this information needs to be conveyed to applications running on the device. Interaction between a user and modality processors are coordinated by a component called an Interaction Manager (IM). It should be noted that, in addition to the modality processors, dialog flow can also be affected by secondary sources such as device state, network state, user preferences, etc., as mentioned above.

To address dynamic discovery and consumer access to device context information, the World Wide Web Consortium (W3C) has worked to standardize a mechanism called Delivery Context Interface (DCI). DCI allows applications to access delivery context information using a Document Object Model (DOM)-like interface. Applications can register event listeners on property nodes that broadcast events based on property or other changes. However, in addition to DCI, there needs to be a mechanism for informing a server of any changes that happen in a device dynamically.

Currently, context access and adaptation technologies have been getting attention with platform and service developments conducted by industry and academia. Certain earlier work has demonstrated the usage of context-aware computing applications on mobile platforms. One approach describes a framework for context aware application development based on sentient objects in ubiquitous environments. Extensive work has also been carried out in context representation forms that describe a context representation framework that is used by intelligent agents performing context based reasoning and behavior. In addition, it has been suggested that a dynamic device profile based on resource description framework (RDF)/extensible markup language (XML) could be implemented. Ontology-based context models in intelligent environments have also been proposed. The industry has also been heavily involved in bringing out context representation models and schemes using device data for application adaptations.

Standards bodies such as the Open Mobile Alliance (OMA) and the W3C are working on device independent technologies and methods of adaptation and context access. One method of presentation adaptation is through the use of Cascading Style Sheets (CSS) media queries that chooses a particular style sheet based on the media type (e.g., desktop, PDA, etc.) that is accessing the web page. Media queries are typically processed at the client device, but servers or intermediaries in the response path can also utilize media query-based presentation adaptation. Another standard, Synchronized Multimedia Integration Language (SMIL), also offers limited support for checking system characteristics where dynamic values are provided by the runtime environment. Such client-based run-time checking help with adapted presentations, but fail to utilize the more dynamic device characteristics due to the limited property sets supported and data discovery mechanisms. OMA's User Agent Profile (UAProf) describes device characteristics using UAProf vocabulary over RDF.

Wireless Universal Resource File (WURFL) is another resource description mechanism that lists all known device capabilities as a single configuration file. This requires that developers update the configuration information themselves and these updates are not managed by any single entity. The underlying principle in all of these mechanisms is that an adaptation entity looks at a capability profile of the client and adapts the content accordingly. However, the properties that these profiles describe do not necessarily have to be static. The user can decide to install a new version of a browser or an entirely new browser in a device. There can be add-on devices such as a Bluetooth connector that increases networking capability or a Global Positioning System (GPS) device for location information. Such changes are not reflected in these static profiles and they tend to be outdated in most cases. The client device always holds the most updated information and a mechanism is needed for soliciting such information by the adaptation entity.

In addition to content adaptation on the server side, browser applications running on the client device can utilize context information for enriching user experience as well as driving a new genre of context-dependent applications. At present, browser applications rely on external services that provide device context information such as location, presence, etc. The applications set up separate sessions with those services through the use of HTTP requests, Web Services (if supported by the device), and other subscription mechanisms. Applications also have to rely on proprietary access methods (typically through JavaScript extensions) for device properties that have to be supported by the browsers as well as the device manufacturers. For utilizing such capabilities, applications have to be tailor-made to run on such platforms. The context-access methods are also property specific and there is no mechanism for dynamically adding new properties while extending content adapation to the context consumers.

Despite the above-discussed proposals, and even though profile extensions are being discussed, a client side API that uses the DCI tree to generate a dynamic device profile would still be useful.

### SUMMARY OF THE INVENTION

Various embodiments of the present invention provide for a client side API that uses a DCI tree to generate a dynamic device profile. The DCI tree represents a hierarchy of nodes, each of which represents a device property. Context providers, via the DCI tree can provide context data to a device profile generator component. The device profile generator component then creates a dynamic device profile, which is used by an application, such as a web browser application, to generate a serialization of device delivery context (i.e., the full DCI tree or part of the DCI tree). This device delivery context is sent to an adaptation server or proxy that performs context-specific content adaptation, allowing a user of the browser application to experience an application session adapted to the specific properties, preferences, etc. of the user's device(s).

Various embodiments of the present invention allow an application author to control when and where to have content adaptation. In addition, proprietary serialization protocols can be defined so that only the relevant application server need understand the protocol. This is useful because there is currently no dynamic profile vocabulary defined. Because most web browsers already provide DOM-based scripting support, integrating a DCI mechanism is easily accomplished. DCI can also be provided as a standalone application independent of a web browser and can be integrated with other interactive components, such as an Interaction Manager (IM) component with a Multimodal Interaction Framework. Furthermore, various embodiments of the present invention complement existing static device profile content adaptation, such as UAProf and WURFL.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a representation of the device context access and content adaptation architecture with which various embodiments of the present invention are implemented;

FIG. 5 is a tree diagram showing a conceptual DCI structure utilized within various embodiments of the present invention; and

FIG. 6 is a screenshot of an application utilizing an embodiment of the present invention.

### DETAILED DESCRIPTION OF THE PREFERRED EMBODIMENTS

The present invention provides for an API that addresses the issue of client side dynamic profile creation. The API provides support for the application author to subscribe to device properties and generate a device profile based on system changes.

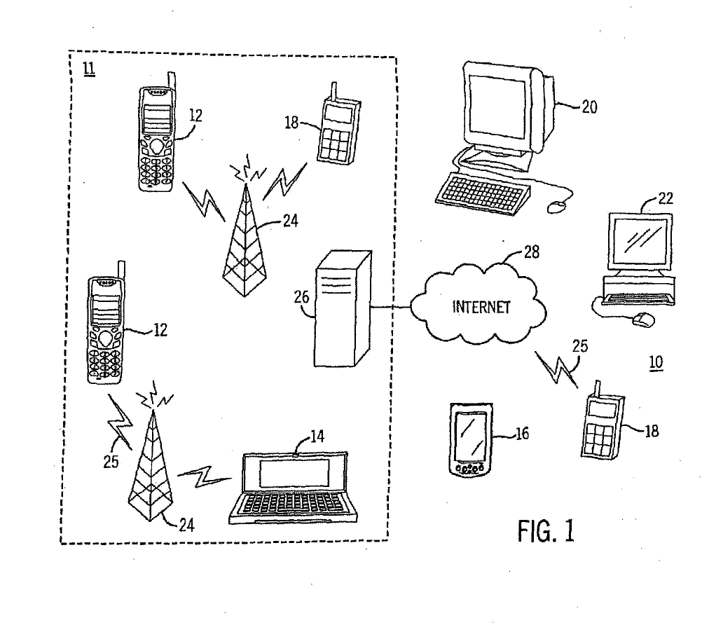

FIG. 1 shows a system 10 in which various embodiments of the present invention can be utilized, comprising multiple electronic devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless electronic devices, whose properties are used to generate respective dynamic device profiles by various embodiments of the present invention.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary electronic devices of the system 10 may include, but are not limited to, a mobile telephone 12, a combination PDA and mobile telephone 14, a PDA 16, an integrated messaging device (IMD) 18, a desktop computer 20, and a notebook computer 22. The electronic devices may be stationary or mobile as when carried by an individual who is moving. The electronic devices may also be located in a mode of transportation including, but not limited to, an automobile, a truck, a taxi, a bus, a boat, an airplane, a bicycle, a motorcycle, etc. Some or all of the electronic devices may send and receive calls and messages and communicate with service providers through a wireless connection 25 to a base station 24. The base station 24 may be connected to a network server 26 that allows communication between the mobile telephone network 11 and the Internet 28. The system 10 may include additional electronic devices and electronic devices of different types.

The electronic devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

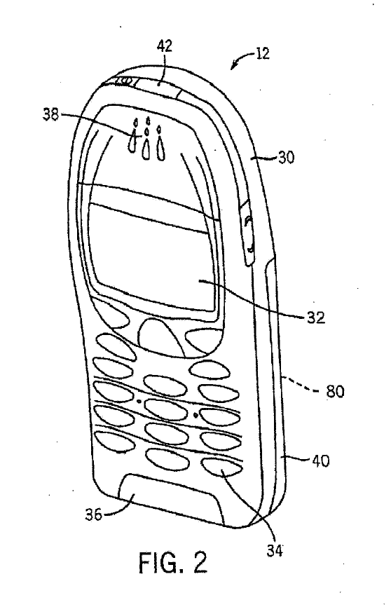

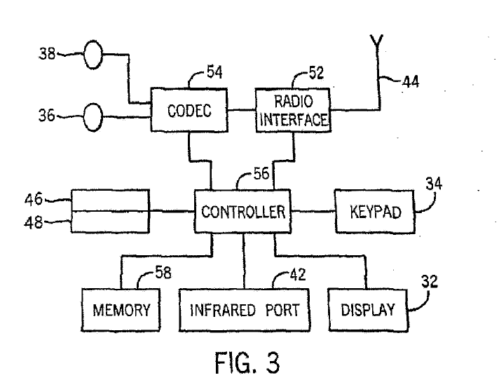

FIGS. 2 and 3 show one representative electronic device 12, whose static and dynamic properties can be used to create a dynamic device profile by various embodiments of the present invention. It should be understood, however, that the present invention is not intended to be limited to one particular type of electronic device. The electronic device 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

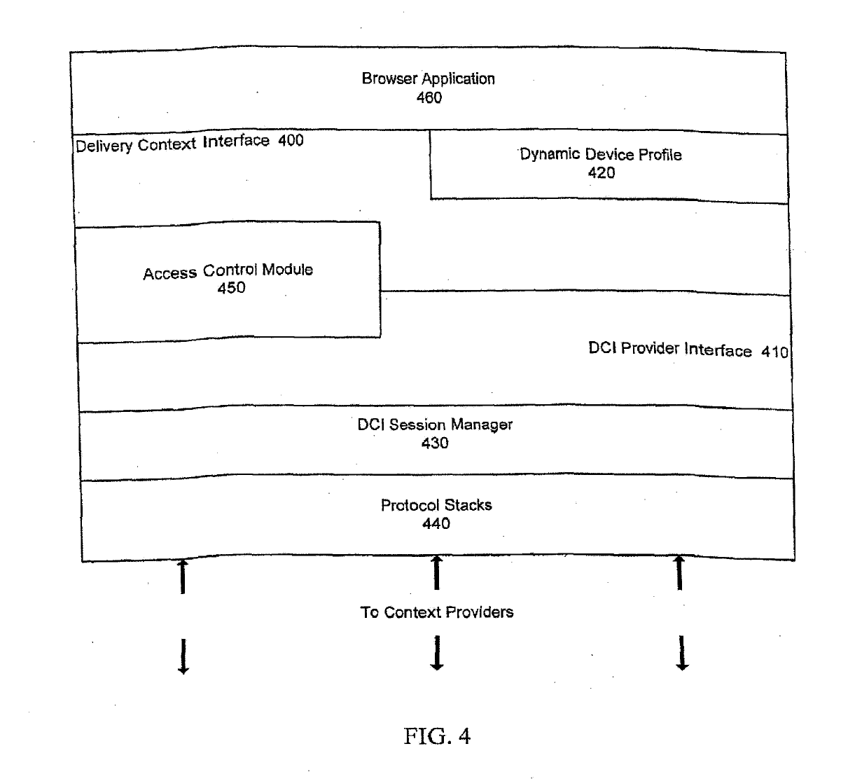

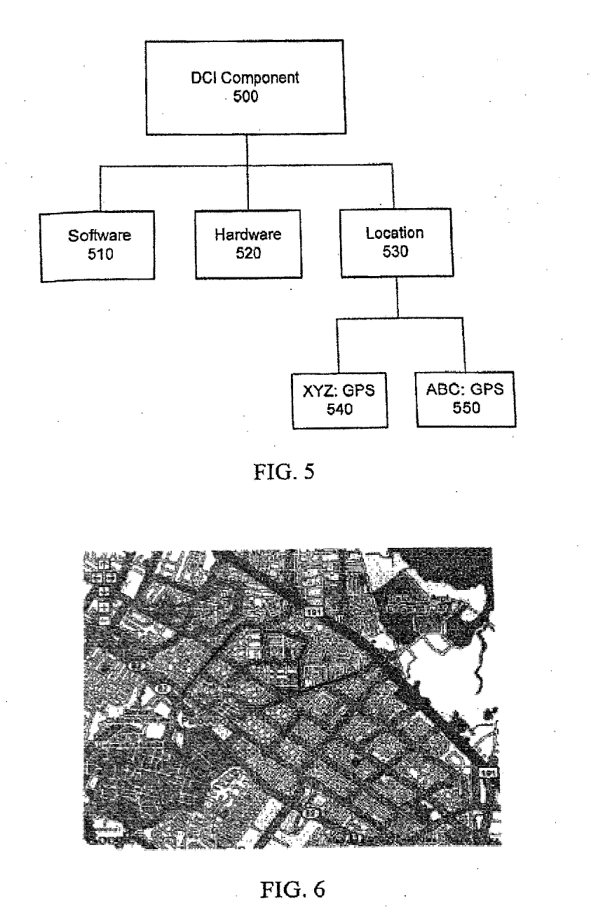

An architecture for device context access and content adaptation is shown in FIG. 4. The root node within the DCI tree of FIG. 5 (described below) for context access is the DCI component 400 as mentioned above. A DCI Provider Interface 410 provides an API set for context providers to supply data to the DCI tree. A Dynamic Device Profile component 420 is used by a Browser Application 460 to generate an XML/RDF serialization of a client device delivery context, which is sent to an adaptation server or proxy that performs device specific content adaptation. When a response from the adaptation server or proxy is received by the Browser Application 460, the content is presented to a user of the Browser Application 460 in a manner adapted to the device delivery context. It should be noted that any applications can use the DCI context provisioning system to access device data. One example is an IM employing DCI services in a multimodal session.

A DCI Session Manager 430 is responsible for managing the access mechanism between the DCI component 400 and external devices or properties. The DCI Session Manager 430 uses different mechanisms for providing access that are platform dependent. Alternatively, the DCI Session Manager 430 can use protocol stacks 440 for communication with context providers (e.g., in Linux, Windows, etc), or a server/client mechanism that is suitable for use with Symbian platforms. An Access Control Module 450 determines where and whether or not to provide access control for external properties within the DCI tree, which will be discussed in greater detail below with reference to FIG. 5. A Dynamic Device Profile 420 provides a snapshot of the DCI tree at any point in time and is used for server-side content adaptation. The individual components shown in FIG. 4 are described in detail below.

As discussed above, DCI is a new approach taken by the W3C, specifically the Device Independence Working Group (DIWG), as an access mechanism for device static and dynamic properties. It is a mechanism that is well-suited to web applications but can also be adapted to work with other frameworks because of the generality and extensibility offered. DIWG advocates this approach as a complementary mechanism to their Composite Capability/Preference Profile (CC/PP) model for server side content adaptation and the delivery context approach for querying and updating properties that are part of the delivery context (DCO).

DCI, as a client-based mechanism, can fit within a content adaptation framework where web content can be adapted based on the capabilities of the device. But, beyond content adaptation, DCI can be used by applications themselves to gather context data and provide application adaptation through simple access methods, thereby reducing reliance on external services for providing the same information. An extensive adoption of DCI platforms enables the generation of a new genre of applications performing intelligent client-based adaptation services that would bring about the next generation of user experience, especially for mobile devices.

The W3C's Document Object Model (DOM) is a platform and language-neutral API that allows programs (scripts) to dynamically access and update the content, structure and style of documents. As used herein, the term “document” refers to representative objects used in the XML-based method of representing different kinds of information that may be stored in diverse systems. The DOM model is the mechanism through which the document (HTML/xHTML) is exposed to application programs as an object model. Through the DOM model, scripts view the document as a hierarchy or as DOM nodes corresponding to each element within a well-formed XML document. The DOM API is used to traverse and manipulate the document objects. DOM also supports an eventing system that involves an event propagation mechanism as well as handlers to listen for and capture broadcasted events. DCI takes a similar approach to representing device properties in a hierarchical manner. This approach is used primarily due to the popularity and familiarity of DOM mechanism among application developers, as well as its compatibility with current browser support for DOM. DCI provides an API for property access by extending the standard DOM interfaces and using the same event mechanism as DOM. It should be noted that DCI requires the latest recommended DOM level and DOM event specifications, which can be found at www.w3.org/DOM/DOMTR and www.w3.org/TR/2000/REC-DOM-Level-2-Events-2000113/, respectively, both of which are incorporated herein by reference.

Referring to FIG. 5, all properties (static and dynamic) are represented as DCIProperty nodes in a tree hierarchy, where a DCIComponent 500 forms the root node. The properties, e.g., Software 510, Hardware 520, and Location 530, are grouped under logical categories to form a hierarchical pattern. New properties are added under specific categories within the tree depending on the property type. DCI extends the DOM Node interfaces with methods for searching and checking for properties. Additional attributes have been defined for the interface including specifying metadata related to properties that scripts can use to decide on the type of property values to look for.

The attribute “propertyType” is a DOMString attribute that can be used to define new property types so that the standard set of DCI interfaces can be extended (based on the property type) to add property specific methods. Examples include, but are not limited to, methods for the initialization of property and update rates for value changes. DCI also provides support for namespaces for property names. This allows the same properties from multiple vendors to be hosted on the DCI tree. Nodes with the same name can be distinguished by their namespace attribute and metadata information as seen with XYZ: GPS Node 540 and ABC: GPS Node 550.

DCI also uses the DOM event model for notification of dynamic value and structural changes. It follows the DOM capture, bubble and target event phases. Modules that implement the DOM EventListener interface, such as a browser or IM, can register as listeners on the DCI/DOM tree, and listen for events at any point in the event path for a target property. All event handlers registered for a particular event and propagation phase are invoked when the event gets broadcast.

Referring to FIG. 4, any context provider that wants to provide data to the DCI tree contacts the DCI Session Manager 430. The DCI Session Manager 430 can be discovered through service discovery mechanisms such as Session Initiation Protocol (SIP) or other procedure calls. The DCI Session Manager 430 provides the translation and session management, and once a context provider is able to contact the DCI Session Manager 430, the DCI Session Manager 430 queries the DCI Provider Interface 410 for a session ID. A session ID is generated if the context provider is authorized by the Access Control Module 450. The Access Control Module 450 deals with access control policies and is used by both the consumer API (DCI 400) and the provider API (DCI Provider Interface 410). Policies can dictate which consumers and providers have access to the DCI tree and have modification rights. Once a session ID is generated, it is up to the DCI Session Manager 430 to manage the session with the context provider. The context provider will then use the unique session ID that was generated for all subsequent communications with the DCI Session Manager 430.

The DCI Provider Interface 410 provides a set of methods for the following:

Searching for the location of a property within the DCI tree;

Checking for properties;

Adding a new property;

Removing an existing property;

Setting a property value;

Getting and setting metadata for a property; and

Setting namespace prefixes for XPath usage

Furthermore, the DCI Provider Interface 410 supports usage of XML Path Language (XPath) expressions for addressing nodes in the DCI tree. XPath is a terse, non-XML syntax for addressing portions of an XML document. A requirement for using XPath expressions is that the expressions should be resolvable within the DCI context. The DCI Provider Interface 410 provides support for the initial setting of a prefix for a namespace Uniform Resource Identifier (URI) so that the prefix can be used with the same XPath expressions that the provider uses. This eliminates the need for a namespace resolution mechanism. The namespace prefix is only valid for the particular provider and is identified based on the unique session ID generated during session establishment, as described above. It should be noted that prefixes must be set before calling any method that uses namespace prefixes.

The DCI Session Manager 430 is also intended to support a context subscription mechanism. Using a context subscription mechanism, consumers can subscribe to remote properties based on protocol stacks supported by the platform they are using. The subscription model can take place through an extended DCI interface.

Device profiles are used by adaptation mechanisms (residing on a proxy, an adaptation server, or the content server itself) for adapting content in accordance with a device's capabilities and the environment it is operating in. The most popular profiling mechanism is currently the User Agent Profile (UAProf) developed by the OMA. The following describes the creation of a dynamic profile that can be generated by web applications utilizing the DCI architecture. The mechanism highlights the use of DCI as a context provisioning mechanism, as well as a source for dynamic profiles that aid with content adaptation.

Referring to FIG. 4, the Dynamic Device Profile module 420 supports a DCI 400 API at the client side for creating a profile that can be sent to the server, e.g., a server hosting Browser Application 460, at any point during a session. The key features of the client side DCI 400 API are:
An application/server can define its own protocol for serialization so it does not have to wait for a dynamic device profile to be standardized;
The client can have multiple serializers available and the application can choose which serializer to use;
Application authors can determine when to send the dynamic device profile to server based on scripting control;
Event mechanisms for dynamic notification are supported;
Conformance to standard DOM mechanism is maintained wherever possible; and
A filter mechanism is provided for getting only those nodes that are needed

The above features are achieved through a series of interfaces. The serializer interface provides a serialize method that takes in a set of DCIProperty nodes and provides a DOMString output. This requires that the active serializer be set through a pervious method call. The application provides a filter interface that determines what nodes within the DCI tree need to be added to a list to be serialized. Thus the logic for filtering properties is handled by the application. The response handler interface is also an application-provided handler. This interface is responsible for handling a response from the server once a profile has been sent. There can be default implementation behavior for handling responses if the interface is not supported by the application. A serialization list interface provides methods for creating a node list for serialization. This interface extends the DCIPropertyList interface and adds additional methods for appending and removing property nodes from the list. The main interface is the dynamic device profile interface that provides support for adding, removing, activating serializers as well as methods for setting response handlers and submitting the profile to the server using a DOMString based method identifier. Additional exceptions have been defined related to the removal of serializers.

One embodiment of an actual DCI API is implemented as follows:

#include dom.idl
#include dci.idl
Module DDP {
//The serialize interface is used to serialize the properties that are present in the list
//parameter. The serializer that the serialize method would use would be the active
//serializer. This returns the serialized profile
Interface serializer {
DOMString serialize (DCIPropertyList list); //returns NULL if there is an error
};
//This filter iterates through the DCI tree and determines what nodes need to be
//added to be serialized. The filter implementation is provided by the application
Interface DDpFilter {
Boolean includeProperty (in DCIProperty property);
};
//The Serialization list interface. This interface is used to add or remove a property
//node to or from the serialization list
Interface DDpSerializationList extends DCIPropertyList {
appendProperty (in DCIProperty);
removeProperty (in DCIProperty);
};
//Response handler: This interface is responsible for handling a response from the
//server once a dynamic profile has been sent. This is provided by the application.
//There can be default behaviour that is implementation dependent if this interface is
//not provided by application
Interface DDPResponseHandler {
Void handleServerResponse (in DOMStringURI uriResponse);
};
//The Dynamic Device Profile interface
Interface DDp {
//The list of serializers available
Readonly attribute DOMStringList serializers;
//Activate a particular serializer for this session
activateDDpSerializer (DOMString slString);
//Get the active serializer - returns the identifier of the active serializer
DOMString getActiveSerializer ( );
//This method is called to set an application-defined serializer. An identifier needs to
//be provided that identifies the serializer
setDDpSerializer (in DOMString identifier, in Serializer NewSerializer);
//This method returns a serializer object upon passing the identifier string
serializer getDDpSerializer(DOMString identifier);
//This method is used to remove a serializer from the serializer list. This method
//raises an exception if the calling application does not have the right to remove a
//serializer
removeDDpSerializer (in DOMString identifier)
raises DDpException;
//Attach an application defined filter to the current serializer
DOMString serializeWithFilter (in DDpFilter filter);
//Create an empty serialization list
DDpSerializationList createSerializationList ( );
//This method is called to serialize the list by calling the current active serializer
DOMString serializePropertyList (in DDpSerializationList list);
//This method is called to submit the device profile to the server identified
//through the URI. The method parameter determines the type of protocol used for
//submission. The behaviour of the return value would depend upon the protocol.
//This is an asynchronous method that immediately returns. The response from the
//server will be handled by the response handler set by the application - see
//“setResponseHandler” method
submitDDp (in DOMString method, in DOMString uri, in DOMString ddpString);
//The response handler is set by the application that will be called when the server
//sends back a response. The handler will then decide based on the response as to what
//to do, for example, reload the page
//If there is none specified, then there will be some default behaviour that is
//implementation-dependent, or it can be assumed to be HTTP by default
setResponseHandler (DDPResponseHandler handler);
};
//The dynamic device profile exceptions
DDPExceptions {
DEFAULT_SERIALIZER_REMOVE_EXCEPTION = 1;
}
}

The W3C DCT Specification does not mention how a DCI object is obtained by applications, leaving the decision to specific implementations of the DCI API. Referring back to FIG. 5, a DCI object is the DCIComponent 500. One way of obtaining the DCIComponent 500 object is through the DOM Document interface “getFeature” method call. In one embodiment of the present invention, the method call is implemented as a JavaScript call:

varDCI=document.getFeature (“org.w3c.dci”,“1.0”);
In another embodiment, a DCI object can be provided within a browser application that allows direct access to the actual DCIComponent 500. It should be noted that a dynamic device profile object can be obtained in the same manner.

An example implementing DCI-based context aware logic is shown in FIG. 6, where a Google Map application running on a Firefox browser is provided with a DCI extension. The Google Map application uses JavaScript based DCI context access to obtain GPS coordinates to plot a user's travel path on a map.

Referring to FIG. 5, a handle to the ABC: GPS Node 550 in the DCI tree is first obtained after traversing from the DCIComponent/root node 500. An event handler is then attached to this node that listens for a “dci_prop_change” event signifying a property value change. The event handler is invoked whenever the GPS value changes and the new value is read by the handler. The new value is then used as the current coordinates and plotted using the polylines feature provided by the Google Map application.

A second example is an application where a simple browser-based dynamic device configuration viewer is implemented using JavaScript. A script iterates through the DCI tree creating text boxes in a hierarchical manner on a web page viewed using the browser, based on the nodes that are present in the DCI tree. If there is a value attribute present, the application will add a handler where the value change will be reflected in the corresponding text box. If a new node is created and added, the change will be dynamically reflected in the application as well.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. An application programming interface, embodied in a computer-readable medium, for accessing device context of a device and adapting content for the device during a session utilizing an application comprising:
a plurality of interfaces for serializing a dynamic device profile of the device;
a list of available serializers;
an activation command for activating one of the available serializers from the list of available serializers during the session;
a plurality of commands configured to set an application defined serializer, return a serializer object, remove a serializer from the list of available serializers, attach an application defined filter, create an empty serialization list, serialize the empty serialization list by calling a current active serializer, and submit the dynamic device profile;
a response handler; and
at least one dynamic device profile exception.

2. The application programming interface of claim 1, wherein the plurality of interfaces includes:
a serialization list interface for adding and removing at least one property node to and from a serialization list, wherein the at least one property node represents a property of the device in a device context interface tree;
a serialize interface for serializing the property of the device represented by the at least one property node in the serialization list and returning a serialized profile, wherein an active serializer is chosen to perform the serializing;
a filter interface for iterating through the device context interface tree to determine what property nodes are to be serialized; and
a dynamic device profile interface for allowing access to the dynamic device profile of the device.

3. The application programming interface of claim 1, wherein the activation command obtains the active serializer and returns an identifier of the active serializer.

4. The application programming interface of claim 3, wherein one of the plurality of commands for setting an application-defined serializer sets the application-defined serializer after the identifier of the active serializer is returned.

5. The application programming interface of claim 3, wherein one of the plurality of commands for returning a serializer object returns the serializer object upon passing the identifier of the active serializer, the identifier represented by an identifier string.

6. The application programming interface of claim 1, wherein one of the plurality of commands for removing a serializer from the list of available serializers raises an exception if the application does not have the right to remove at least one of the available serializers.

7. The application programming interface of claim 1, wherein one of the plurality of commands for submitting the dynamic device profile submits the dynamic device profile to an adaptation server identified by a universal resource identifier, the adaptation server performing context-specific content adaptation, and wherein a method parameter determines a protocol type used for the submitting.

8. The application programming interface of claim 7, wherein the response handler is set by the application to be called when the adaptation server sends a response to the application upon the submitting of the dynamic device protocol, the response handler determining an action to take based upon the response to the application.
